(19) United States
(12) Patent Application Publication
(10) Pub. No.: US 2019/0316367 A1
(43) Pub. Date: Oct. 17, 2019

(54) MASON'S ADJUSTABLE CHIMNEY-PLATFORM ARRANGEMENT

(71) Applicants: Donald F. Lombardi, Manchester, MA (US); Luke A. Lombardi, Manchester, MA (US)

(72) Inventors: Donald F. Lombardi, Manchester, MA (US); Luke A. Lombardi, Manchester, MA (US)

(21) Appl. No.: 16/501,872

(22) Filed: Jun. 22, 2019

Related U.S. Application Data
(62) Division of application No. 14/756,317, filed on Aug. 25, 2015, now abandoned.
Application No. 14/756,317 is a continuation-in-part of application No. 14/544,133, filed on Nov. 29, 2014, now Pat. No. 9,114,967.
Application No. 14/544,133 is a continuation of application No. 12/658,868, filed on Feb. 16, 2010, now Pat. No. 8,899,379.
Application No. 12/658,868 is a continuation-in-part of application No. 12/287,787, filed on Oct. 14, 2008, now Pat. No. 7,661,372.
Application No. 12/287,787 is a division of application No. 11/499,374, filed on Aug. 5, 2006, now Pat. No. 7,434,521.

(51) Int. Cl. E04G 1/22; B66F 11/04; E04G 1/36; E04G 3/28; E04G 3/24

(52) U.S. Cl. CPC E04G 1/22; B66F 11/046; E04G 1/362; E04G 3/24; E04G 3/28; E04G 3/243; E04G 2003/286; B66F 11/04

(57) ABSTRACT

An adjustable platform assembly for supporting workers and supplies about an elevated work site, the platform assembly being movably supported on an articulable support, the platform comprising a stationary curvilinear rear bridging panel arrangement having a 1^{st} side curvilinear platform member and a 2^{nd} side curvilinear platform member, each comprising a floor and railing assembly, wherein each elongated 1^{st} and 2^{nd} curvilinear side platform member floor and railing assembly is independently movable on support members outwardly and inwardly, with respect to the curvilinear bridging panel arrangement, to change the platform assembly back and forth between a generally “C” shape to a generally “O” shape, or any peripherally adjustable combination thereof, as required.

### BACKGROUND OF THE INVENTION

### Field of the Invention

This invention relates to lift platforms to facilitate chimney construction, and more particularly to articulable lift platforms attachable to mechanical arm arrangements to be utilized for construction at above the ground locations. This application is a Continuation-In-Part application of application Ser. No. 14/544,133, filed Nov. 29, 2014, now U.S. Pat. No. 9,114,967, which was a Divisional application of application Ser. No. 12/658,868, now U.S. Pat. No. 8,899,397 which is a Continuation-In-Part application of U.S. patent application Ser. No. 12/287,787, now U.S. Pat. No. 7,661,372, which is a divisional application of U.S. patent application Ser. No. 11/499,374 now U.S. Pat. No. 7,434,521, each of which is incorporated herein by reference in its entirety.

### Prior Art Discussion

The construction industry, particularly that which is involved in the home and building field have a difficult time reaching elevated structures, such as chimneys on roofs or the like, to rebuild them or to get around them. Often those structures are several stories high off of the ground. Movement and work space around them is too often very limited.

Those in the masonry business may readily attest to this. Getting bricks, mortar and personnel to an elevation several stories above the ground, and keeping them there in a safe and stable manner where they can productively work is something much to be desired.

It is a further object of the present invention to provide an articulable platform which is adapted to the attached to the distal end of an articulable arm, for safe hoisting and lowering of personnel and equipment to a roof of a building.

It is a further object of the present invention, to provide an articulable platform which may be adapted to the particular construction irregularities of a particular work site.

It is still yet another object of the present invention, to provide a work space or platform which is maneuverable, safe and has the ability to be changed and controlled in its elevated most position.

It is a further object of the present invention to provide an adaptable platform arrangement which may have side platform portions which may be individually moved about a curved foundation on their support bases to be permitted to surround, apply transverse pressure or provide spaced-apart or close accommodation to a vertical or non-rectilinear structure more readily.

It is yet another object of the present invention to provide an adaptable platform arrangement which will be movable circumferentially to closely align itself with the periphery of curvilinear vertical (round or generally round) structures such as chimneys, piers, columns, standpipes, storage tanks, lighthouses or the like.

### BRIEF SUMMARY OF THE INVENTION

The present invention comprises an articulable platform which is securable to the distal end of an articulable arm. The articulable arm is typically telescopingly arranged on the distal end of a movable arm supported on a lift truck. The lift truck provides a mobile base from which the articulable platform may be moved and adjusted.

The articulable arm has a distalmost end with a securement member thereon. The platform has a lower anchor plate and a lower support frame to which the securement member is attached, by a bolt and slider mechanism. A rear wall plate is attached to the lower anchor plate and the lower support frame. A right sidewall frame and a left sidewall frame are attached to the respective side edges of the rear wall frame.

The present invention comprises an adjustable platform for supporting workers and supplies about an elevated work site, the platform being movably supportable preferably on an articulable support arm. The platform comprises an elongated semi-circular bridging panel arrangement and an elongated curved floor and railing assembly at each end thereof, wherein each elongated curved floor and railing assembly are independently movable on support members outwardly and inwardly with respect to the semi-circular bridging panel arrangement to change the platform from a generally semicircular shape to a half or full circular shape or with any combination of one curved side platform extending fully or partially outward or inward with the other curved side platform extending either fully outward or partially outward or inward from the bridging panel arrangement, as required.

The invention also comprises an articulable, elevated-structure-engaging platform assembly, adjustable between a semi-circular shape, a ¾ circular shape or combination thereof, the platform assembly being attachable to an overhead support, the platform assembly being arranged to adjustably fully surround an elevated circular structure, the platform assembly comprising: a stationary generally semi-circular anchor plate support frame bridging member comprising a rear floor; a right side curved platform and a left side curved platform both slidably connected to and supported from beneath the semi-circular anchor plate support frame bridging member rear floor, to provide adjustable “curved side” portions to the platform assembly, the curved side portions each being movable in a direction away from and returnable in a direction towards and under the semi-circular rear floor, with their distalmost ends movable towards and away from one another, so as to be articulable around at least one semi-circular side of an elevated circular structure for lifting, supporting and even closely squeezing the structure, with personnel and equipment thereat. The right and left curved side platforms are preferably movable independently with respect to one another. The right side platform and/or the left side platform are of curved configuration for all of its/their length.

The overhead support structure preferably may also comprise at least one crane or derrick. The at least one crane or derrick preferably has a plurality of cables connected to the platform assembly to maintain stability of that platform assembly. The cables are preferably connected to both distal ends of the curved side platforms. The curved side platform may be attached to the lower side of the curved bridging member by a curvilinear support and movement empowerment means therebetween, to permit the supported, controlled in and out movement of the curved side platform(s) with respect to the curved bridging member. The movement empowerment means may comprise a properly controlled worm gear arrangement between the curved bridging member support arrangement and each curved side platform.

The invention also comprises an adjustable platform assembly for supporting workers and supplies about an elevated work site, the platform assembly being movably supported on an articulable support, the platform comprising a stationary curvilinearly shaped rear bridging panel arrangement having an curved, elongated side platform member floor assembly at each end thereof, wherein each curved, elongated side platform member floor assembly is preferably independently movable on support members forwardly, rearwardly, with respect to the curved bridging panel arrangement to change the platform assembly back and forth between a generally “C” shape to a generally “O” shape, or any skewed combination thereof, as required.

The present invention thus comprises an articulable, elevated-structure-engaging circularly adaptable platform assembly, adjustable between an “C” shape to a “O” shape or combination thereof, the platform assembly being attachable to an overhead support, the platform assembly being arranged to adjustably surround an elevated structure on at least 180° periphery thereof, the platform assembly comprising: a stationary anchor plate support curvilinear frame bridging member comprising a curvilinear rear floor; a Pt side curvilinear platform and a 2^{nd} side curvilinear platform slidably and supported on the anchor plate support curvilinear frame bridging member curvilinear rear floor, to provide adjustable curved 1^{st} and 2^{nd} side portions to the platform assembly, the curved 1^{st} and 2^{nd} side portions each being movable by a movement means away from and returnable towards the curvilinear rear floor, so as to be articulable around at least about 180° of the circumference of an elevated structure for lifting and supporting the structure, personnel and equipment thereat. The curvilinear 1^{st} side platform is movable independently with respect to the curvilinear 2^{nd} side platform. The overhead support structure may comprise at least one crane or derrick. The at least one crane or derrick has a plurality of cables connected to the platform assembly to maintain stability of that platform assembly. The cables are preferably connected to the distalmost ends of the curved side platforms. The movement means preferably comprises a controlled rack and pinion gear arrangement.

The invention also comprises a method of supporting a work crew on an elevated structure, comprising: attaching a generally “C” to “O” shaped articulable platform assembly to an overhead support, wherein the platform assembly is arranged to adjustably surround a generally circular elevated structure about at least 180° therearound; moving at least one curvilinear side platform member with respect to a stationary curvilinear rear bridging member of the platform assembly so as to re-shape the platform assembly, thereby forming at least a partial structure-periphery surrounding work-crew platform assembly; moving the 1^{st} side curvilinear platform member and the 2^{nd} side curvilinear platform member independently of one another, wherein the 1^{st} curvilinear side platform and the 2^{nd} side curvilinear platform each have support rails which positionally overlap one another, for example, side-by-side, in their fully stored configuration; and wherein the platform assembly may be supported from the overhead support by a plurality of cables.

The invention may also comprise an adjustable platform assembly for supporting workers and supplies about an elevated circular work site, the platform assembly being movably supported by an articulable support, the platform comprising a stationary curvilinear rear bridging panel arrangement having a elongated 1^{st} side curvilinear platform member and a 2^{nd} side curvilinear platform member both comprising a floor and railing assembly, wherein each 1^{st} and 2^{nd} curvilinear side platform member is independently movable on support members outwardly and inwardly with respect to the curvilinear bridging panel arrangement to change the platform assembly back and forth between a generally “C” shape to a generally “O” shape, or any incomplete circular combination thereof, as required.

### BRIEF DESCRIPTION OF THE DRAWINGS

The objects and advantages of the present invention will become more apparent, when viewed in conjunction with the following drawings in which:

FIG. 1 is a side elevational view of a lift truck and arm arrangement adapted to move an articulated first embodiment platform, in a side elevational view showing an exemplary platform in several positions of the platform against a building structure;

FIG. 2 is a side elevational view of the rear wall of the platform;

FIG. 2A is a view taken along the lines 2A-2A of FIG. 2;

FIG. 2B is a view taken along the lines 2B-2B of FIG. 2;

FIG. 2C is a view taken along the lines 2C-2C of FIG. 2;

FIG. 3 is an elevational view of the rear wall of the platform, with portions of the floor and sidewalls thereattached;

FIG. 3A is a view taken along the lines 3A-3A of FIG. 3;

FIG. 3B is a view taken along the lines 3B-3B of FIG. 3;

FIG. 3C is a view taken along the lines 3C-3C of FIG. 3;

FIG. 4 is a side view of the articulable platform and its associated lift arm at different locations about a structure;

FIG. 5 is a plan view of the platform fully extended;

FIG. 6 is a plan view of the platform partially extended;

FIG. 7 is a plan view of the platform with a front floor thereattached;

FIG. 8 is a plan view of a platform with a number of floor inserts shown arranged therein;

FIG. 9 is a plan view of an insert utilized in the floor plan of the present articulated platform;

FIG. 10 is an elevational view of the rear wall showing a further embodiment of transverse telescoping adjustability thereof;

FIG. 11 is a plan view of the side platforms and the rear platform with its further embodiment of transverse and/or pivotable adjustability thereof being supportable from an overhead arrangement of cranes or the like;

FIG. 12 is a plan view of a further embodiment comprising a circular platform arrangement constructed according to the principles of the present invention;

FIG. 13 is a view taken along the lines 13-13 of FIG. 12;

FIG. 14 is a view taken along the lines 14-14 of FIG. 12;

FIG. 15 is a view taken along the lines 15-15 of FIG. 12;

FIG. 16 is a view taken along the lines 16-16 of FIG. 12.

### DETAILED DESCRIPTION OF THE PREFERRED EMBODIMENT

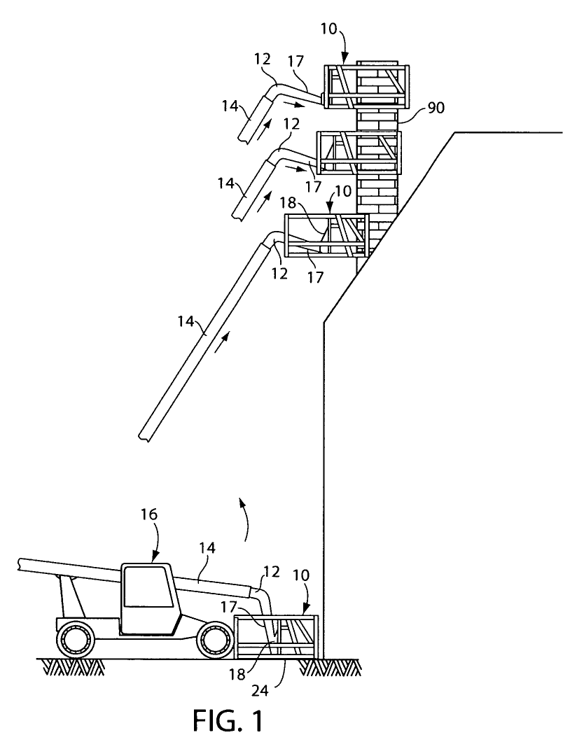

Referring now to the drawings in detail, and particularly to FIG. 1, there is shown a first embodiment of the invention which comprises an articulable platform 10 that is securable to the distal end of an articulable arm 12, as best represented in my earlier U.S. Pat. Nos. 9,114,967 and 8,899,379, each being incorporated hererin by reference, in their entirety. Those patents teach that the articulable arm 12 is typically telescopingly arranged on the distal end of a movable arm 14 supported on a lift truck 16. The lift truck 16 provides a mobile base from which the inventive articulable platform 10 may be moved and adjusted around an elevated chimney 90, or the like, to provide a mason's platform during work on that chimney 90.

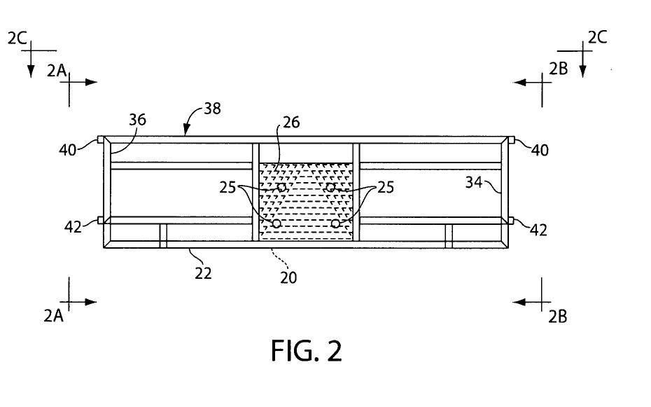

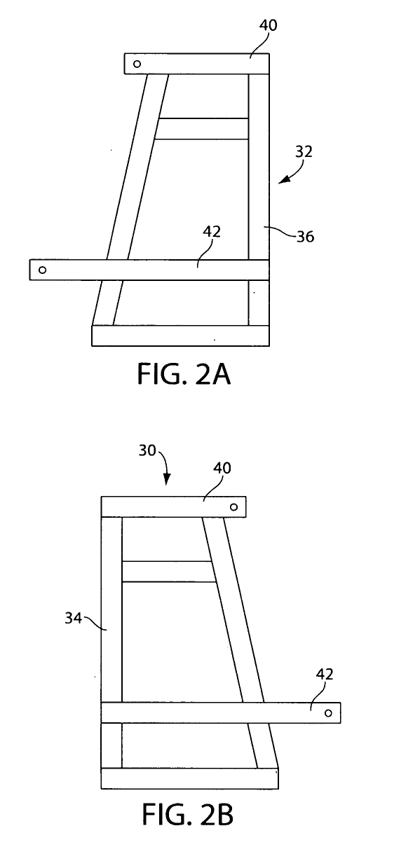

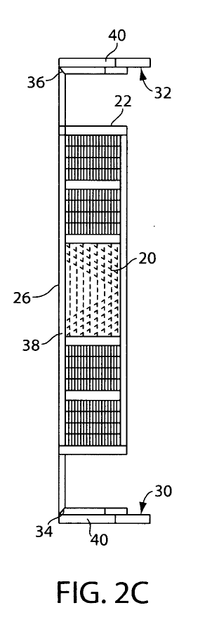

The articulable arm 12 has a distalmost end 17 with a generally “L” shaped (in cross-section) platform securement member 18 thereon. The articulable platform 10 has a preferably first embodiment as a rectangularly-shaped lower anchor plate 20 and an elongated rectangular, lower peripheral support frame 22 to which the lower extremity of the “L” shaped platform securement member 18 is attached at several points, by a bolted anchor mechanism 24, as partially represented in FIG. 1. A rear anchor plate 26 is rigidly and fixedly attached, as for example by welding, in a perpendicular manner to the bottom side of the lower anchor plate 20 and the lower support frame 22. The securement member 18 also preferably being secured to the rear anchor plate by another bolted anchor mechanism 24, secured through bolt holes 25, as best represented in FIG. 2.

A right sidewall frame 30, best represented in FIG. 2B and a left sidewall frame 32, best represented in FIG. 2A, are each attached, as for example, by welding, to and define the respective right and left side frame members 34 and 36 of the rear wall frame 38, as represented in FIG. 2. The respective sidewall frames 30 and 32 each have an upper elongated channel 40 and a lower elongated channel 42 parallel to one another, as shown in FIGS. 2A and 2B. The length of upper elongated channel 40 is approximately one half of the length of its adjacent lower elongated channel 42, to provide stronger support to floor panels telescopingly supported thereby, near the lower channel 42 on the platform 10.

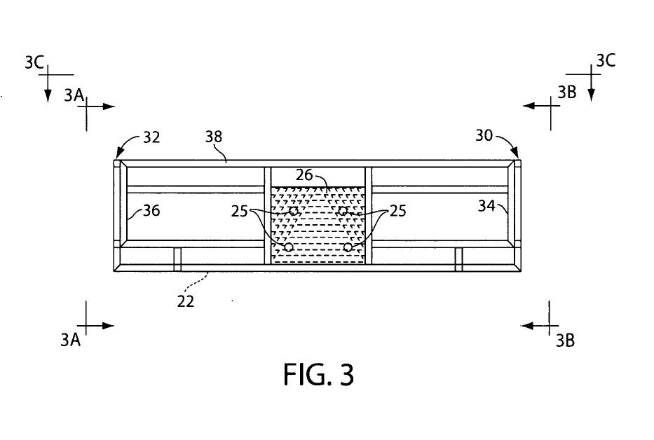

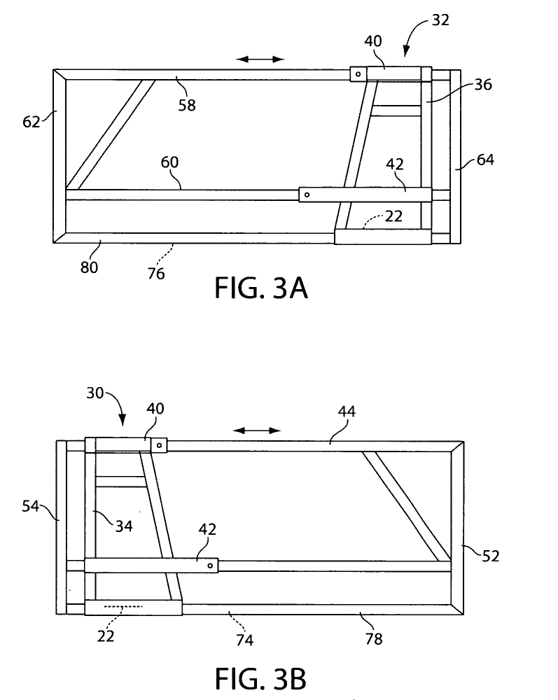

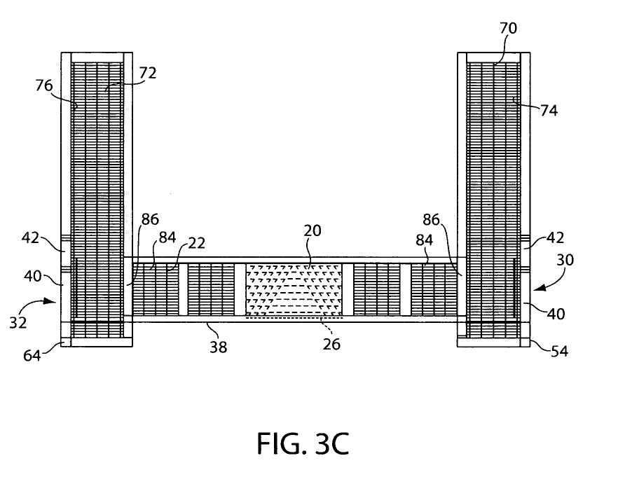

The sidewall frames 30 and 32, connected to the rear wall frame 38, each slidably support a slidable side wall 44 and 46 respectively, as represented in FIGS. 3A and 3B. An upper right rail 48 of the right slidable sidewall 44, shown in FIG. 3B, telescopingly slides through the supportive upper elongated tubular channel 40 of the right sidewall frame 30. A lower rail 50 of the right slidable side wall 44 telescopingly slides through the supportive lower elongated tubular channel 42 of the right sidewall frame 30, as shown in FIG. 3B. The right slidable sidewall 44 has a transverse bar 52 at its distalmost end. The right slidable sidewall 44 has a right-side proximal transverse bar 54 at the rear or proximal end of the right slidable sidewall 44, as represented in FIG. 3B. The right-side proximal transverse bar 54 closely butts into a right sidewall frame 38 transverse bar edge 34 when the right slidable sidewall 44 is extended distally its maximum amount, as taught in my aforementioned referenced '967 and '379 Patents.

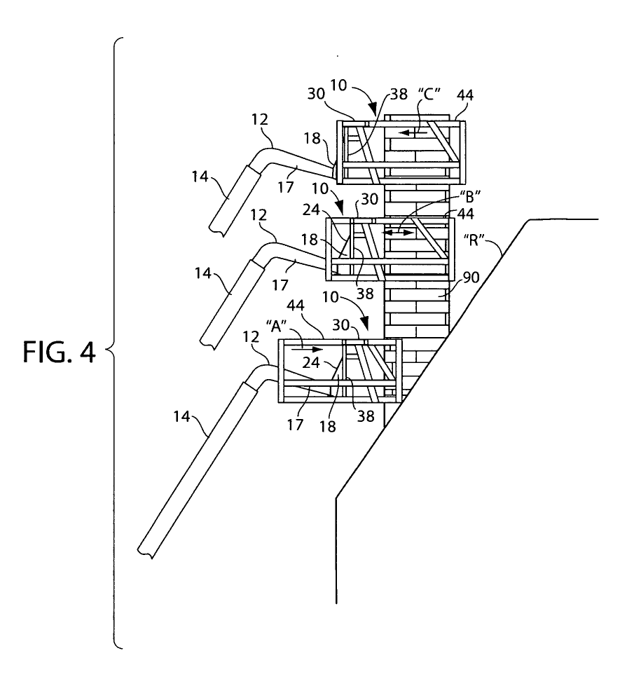

The left sidewall frame 32 has a left slidable sidewall 46 arranged in a similar manner to the aforementioned right sidewall frame 30. An upper left rail 58 of the left slidable sidewall 46 slides telescopingly through the supportive upper elongated tubular channel 40 of the left sidewall frame 32 as represented in FIG. 3A. A lower rail 60 of the left slidable sidewall 46 slides through the supportive lower elongated channel 42 of the left sidewall frame 32. The left slidable sidewall 46 has a transverse bar 62 at its distalmost end and it has a transverse bar 64 at its proximal end. The left-side proximal transverse bar 64 closely butts into a left sidewall frame 38 transverse bar edge 37 when the left slidable sidewall 46 is extended distally its maximum amount, as represented in FIG. 3A and the uppermost representation of the assembly shown FIG. 4, as taught in my aforementioned referenced '967 and '379 Patents.

The right slidable sidewall 44 and the left slidable sidewall 46 each have an elongated fold-down support plate or panel member 70 and 72 respectively, as represented in FIG. 3C. Each sidewall 44 and 46 is connected to their respective support panel or plate 70 and 72 by an elongated distally disposed hinge 74 and 76 connectively arranged along respective lower bar portions 78 and 80 thereof between the plate members 70 and 72. The support plates 70 and 72 are supported on their “hinge-opposite” sides by a lip thereof using ridably sliding support on the lower support frame 22. Each left and right slideable sidewall 46 and 44 has their lower bars 78 and 80, respectively, movable along with their respective left and right slidable sidewalls 44 and 46, the lower bar 78 and 80 of each being hingedly attached to the elongated side plates 70 and 72 which may also be pivoted into supported engagement with a portion of the rear floor 84 on each side of the lower anchor plate 20, which is part of the lower support frame 22. The outer edge of each rear floor 84 has a support edge 86 on which the elongated hingedly pivotable side support plate members 70 and 72 may themselves supportively slide/rest.

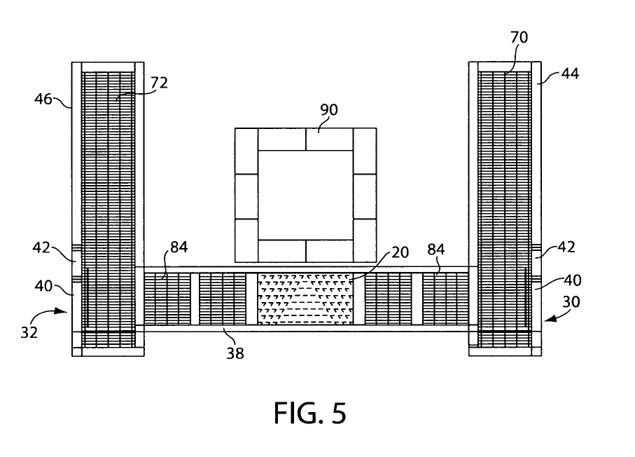

In operation of the articulable platform 10 on the distal end 17 of the articulable arm 12 on the lift truck 16, that articulable platform 10 may engageably receive between its elongated side floors 70 and 72, with a chimney or vertical structure 90 therebetween, as represented by side views in progressive stages of extended engagement of the arm 12, and concomitant extension of the sidewalls walls 44 and 46, and the platforms 70 and 72, as represented in FIG. 4, and in a plan view in FIG. 5, going from an “H” shape to a “U” shape in plan view. Those slidable sidewalls 44 and 46 may be moved forwardly and rearwardly, that is away from and back towards the rear wall frame 38, as represented by arrows A, B and C shown in the different positions of the sidewalls 44 and 46 in FIG. 4. For instance, if the platform 10 were utilized above a chimney 90 on a slanted roof “R”, the slidable sidewalls 44 and 46 would only be independently extended from their respective right sidewall frame 44 and left sidewall frame 46 enough to clear the sides of the chimney without damaging any inclined roof “R” thereadjacent, but the distal ends may rest upon such roof “R” as necessary, as taught in my aforementioned referenced '967 and '379 Patents.

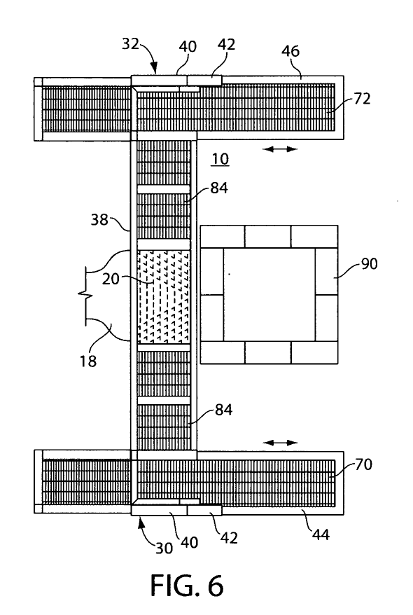

To fully surround a chimney or structure 90, as represented in a plan view in FIG. 5, those independently slidable sidewalls 44 and 46 and their respective hingedly associated support plates 70 and 72 would be extended away from the rear wall frame 38 so as to provide the elongated side floors their full extendibility thereadjacent, as shown in FIG. 5. FIG. 6 represents a plan view of the platform 10 in a partially extended mode, relative to the chimney 90, and shows the platform's configuration in the “H” shape.

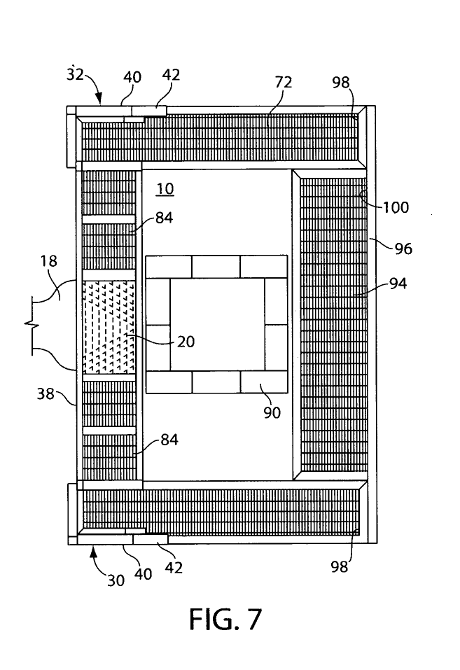

It is further contemplated that an elongated, rectilinearly shaped front floor plate 94 with a hingedly attached front wall 96 may be adjustably and removably disposed between the respective distalmost ends of the respective properly reinforced supportive elongated side plates 70 and 72, as represented in FIG. 7. The front floor plate 94 preferably includes a proper corner attachment coupler 98 secured at each end of the front of the floor plate wall 96 to the ends of the respective left and right slidable sidewalls 44 and 46. The front wall 96 and front floor plate 94 may be hingedly attached to one another by an elongated hinge 100 or weldably attached along their connective adjacent portions thereof.

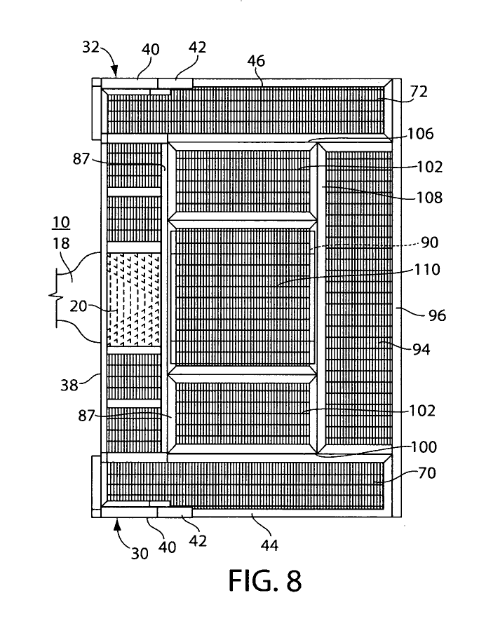

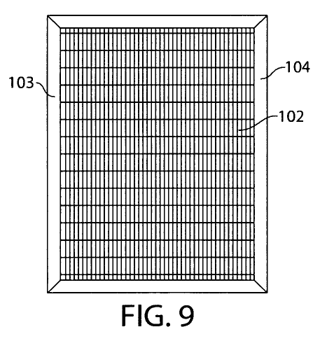

An arrangement of rectilinear Inserts 102 may be disposed between the chimney 90 and the elongated edges of the elongated side floors 70 and 72, and the edges 87 of the rear floor 84 and the front floor 94 for in-close support of personnel and material on the platform 10, as is represented in FIG. 8. Such an insert 102 is represented in FIG. 9, in a plan view thereof. The insert 102 comprises a lipped rectilinear frame 104 having edge shoulder portions which properly rest upon the adjacent edges 106 and 108 of the floors 70 and 72 and the front plate 94, respectively, as represented in FIG. 8. Also shown in FIG. 8 is a central support plate 110, above the chimney 90, which is shown in dashed format. Such a central plate 110 has peripheral shoulder edges for proper restive support on adjacent peripheral plates 102, 94 and 84, when needed. Angle iron members, not shown for clarity of views, may be arranged between the side floors 70 and 72 for as needed peripheral support of various panel members, where such support is proper, as taught in my aforementioned referenced '967 and '379 Patents.

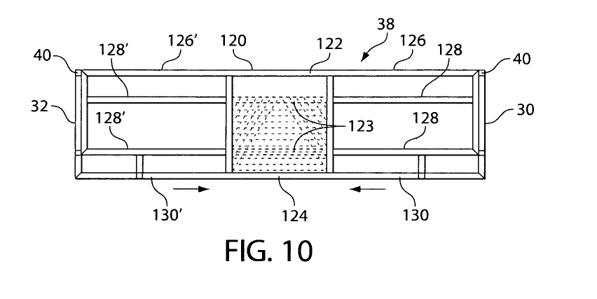

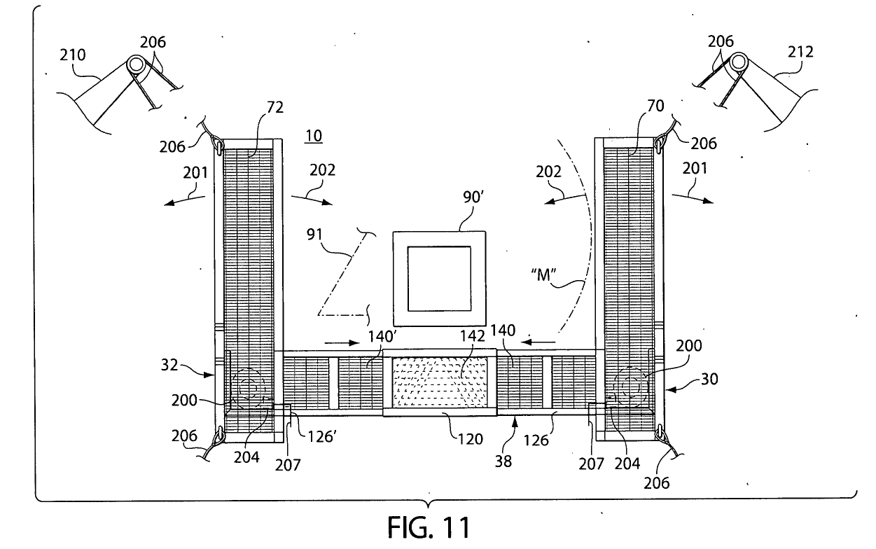

A further preferred embodiment of the invention taught in the aforementioned '967 and '379 Patents is shown in FIG. 10, wherein the rear wall frame 38 is divided into a unitary mid-portion 120 having upper, intermediate and lower rail members 122, 123 and 124, through which right end and left end wall portions rail members 126, 128 and 130, and 126′, 128′ and 130′ of rear wall frame 38 respectively slide supported therethrough, telescopingly or otherwise surely supported in a proper manner thereby. Such an adjustable slidability to the right and left end wall portions 126 and 126′ is also represented in FIG. 11, showing transversely shiftable deck panels 140 and 140′ which are adjustably slidable under the “bridging” portion mid-portion deck panel 142. This side-independent limited transverse movability is important to provide floor panels with support to workers working on a narrow chimney or small project 90′ requiring close work/material support. Note that such a mid-portion deck panel 142 may have an underside bridging member which is attachable to the generally “L” shaped platform securement member 18, to facilitate proper movement of such side floors without interference of the lift arm and its member 18. FIG. 11 shows the platform 10 in a plan view somewhat between the “H” and the “U” shape.

FIG. 11 also shows a rotary support unit means 200 arranged between each of the shiftable side deck panels 140 and 140′ and their respective side platform members 30 and 32 for further articulation thereof. The side platforms 30 and 32 may be curved along all of part of their length as shown by the dashed line M on the right side platform 32. Each supportive rotary unit 200 permits each respective side platform member 30 and/or 32 to pivot or swivel transversely with respect to the longitudinal axis of the connecting bridge 120, the pivotabilty being indicated by the arrows 201 and 202. This permits at least one side platform 30 or 32 of the platform arrangement 10 to be moved angularly into close non-orthogonal proximity towards and/or moved away and/or around and from any structure or building 90′ or any non-rectilinear structure 91 being worked upon, such as for example, a tree, a pole or an aircraft tail. Such rotary support units 200 may be rotatively driven by properly empowered and also controlled by, for example, a pair of hydraulically, pneumatically or electrically powered, platform-controlled, worm gear arrangements 204, as represented in FIG. 11, the power supply not shown for clarity of drawings. Such power may for example, also be a manual crank 207 to turn the worm gear arrangement 204 for rotatively moving its respective side platform 30 and/or 32 on its rotary unit 200, as needed. Each rotary unit 200 may be comprised of a proper rotary support table and platform guiding track on the rotary support table for permitting both rotative and linear motion of the side platforms 30 and/or 32 with respect to the bridge 120.

It is to be further noted that the platform assembly 10 may be itself supported from one or more overhead cranes or derricks preferably at multiple connections on each crane or derrick 210 and 212, which platform assembly 10 is supportively connected to those (multiple) crane/derrick connections by a plurality of cables 206, partially represented in FIG. 11, which multiply supported cables 206 prevent the platform arrangement 10 from twisting or moving angularly with respect to any structure 90′ or 91, being worked upon, as taught in my aforementioned referenced '967 and '379 Patents.

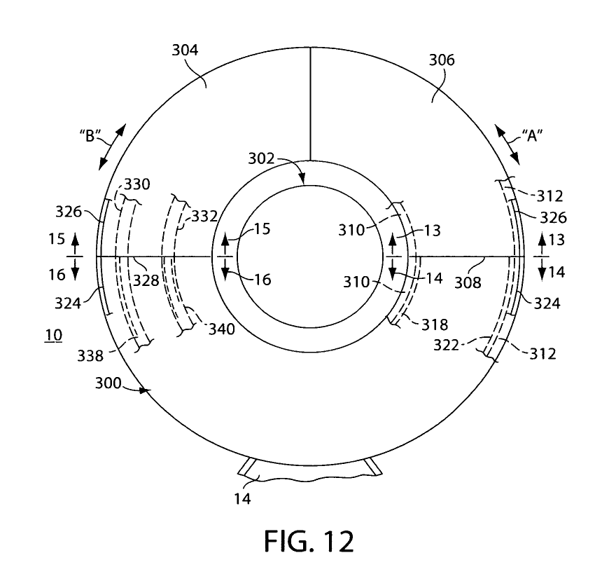

Now however, proceeding to the present newest and presently claimed embodiment of the platform assembly 10 invention, as represented in FIGS. 12 through 16, there is shown in a plan view a curvilinear bridging platform 300, otherwise supported on arm, as earlier shown in FIG. 1 as number 14 in the earlier embodiment, but not fully shown in this view for clarity of the figures. The platform assembly 10 is shown surrounding a generally circular structure 302, which may for example, be a chimney, tower, columns, standpipes or the like. The curvilinear bridging platform 300 may have an outer periphery which extends through an arc of about 120° to no greater than 180°. The curvilinear bridging platform 300 supports a 1^{st} side curvilinear platform 304 and a 2^{nd} side curvilinear platform 306, as represented in FIG. 12. The 1^{st} side curvilinear platform 304 and the 2^{nd} side curvilinear platform 306 together with the curvilinear bridging platform 300 constitute a full circular 360° for surrounding a generally circular structure 302. The 1^{st} side curvilinear platform 304 may thus have an arcuate periphery of from about 90° to 120°. Similarly, the 2^{nd} side curvilinear platform 306 may have a corresponding arcuate periphery of from about 90° to 120° depending of course on the extent of the arcuate periphery of the curvilinear bridging platform 300 and the arcuate periphery of the 1^{st} side curvilinear platform 304.

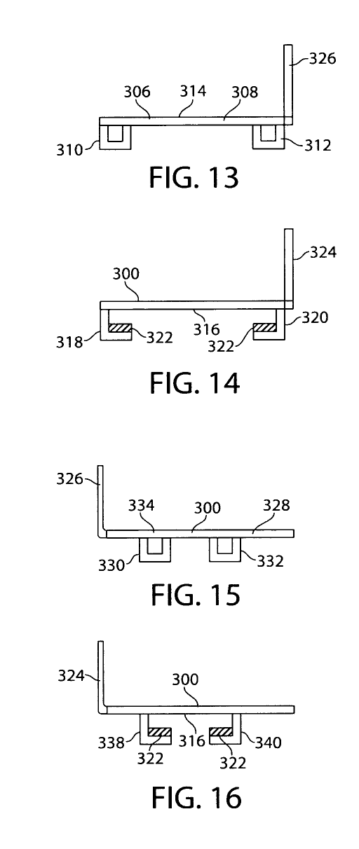

The 2^{nd} side curvilinear platform 306 is shown in a proximal end view in FIG. 13. The 2^{nd} side curvilinear platform 306 as a proximal end 308 as represented in FIGS. 12 and 13. The 2^{nd} side curvilinear platform 306 has for example, a pair of curvilinear rails 310 and 312 which extend beyond the proximal end 308 of the 2^{nd} side curvilinear platform 306 as may be seen in FIG. 12. The 2^{nd} side curvilinear platform 306 as an upper surface 314 which slides beneath a lower surface 316 of the curvilinear bridging platform 300. The curvilinear rails 310 and 312 extend into and are movably supported, for example, in an elongated pair of spaced apart support rails 318 and 320 as may be seen in FIG. 14. The support rails 318 and 320 have side rail engagement and movement means 322 to effect arcuate displacement of the 2^{nd} side curvilinear platform 306 with respect to the curvilinear bridging platform 300, as indicated by the arrow “A” in FIG. 12. The curvilinear bridging platform 300 may have a perimeter rail 324 extending their around, as represented in FIG. 14. The 2^{nd} side curvilinear platform 306 may have an adaptable perimeter rail 326 which is installed by a worker as the 2^{nd} side curvilinear platform is moved outwardly from a storage configuration beneath the curvilinear bridging platform 300.

Similarly the 1st side curvilinear platform 304 is shown in a proximal end view in FIG. 13. The 1st side curvilinear platform 304 has a proximal end 328 as represented in FIGS. 12 and 13. The 1st side curvilinear platform 304 has for example, a pair of curvilinear rails 330 and 332 which extend beyond the proximal end 328 of the 1st side curvilinear platform 304 as may be seen in FIG. 12. The 1^{st} side curvilinear platform 304 has an upper surface 334 which slides beneath a lower surface 316 of the curvilinear bridging platform 300, as may be appreciated in FIGS. 15 and 16. The curvilinear rails 330 and 332 are movably supported in for example, an elongated pair of spaced apart support rails 338 and 340 as may be seen in FIG. 14. The support rails 338 and 340 have side rail engagement and movement means 322 such as for example, a rack and pinion arrangement, preferably controlled by proper control means on the curvilinear bridging platform 300, (the control means not shown for clarity of the drawings), to effect arcuate displacement of the 1st side curvilinear platform 304 with respect to the curvilinear bridging platform 300, as indicated by the arrow “B” shown in FIG. 12. The curvilinear bridging platform 300 may have a perimeter rail 324 extending their around, as represented in FIG. 16. The 1st side curvilinear platform 304 has an adaptable perimeter rail 326 which may be installed by a worker as the 1st side curvilinear platform has been moved outwardly from a storage configuration beneath the curvilinear bridging platform 300.

The width of the respective 1^{st} side curvilinear platform 304 and the 2^{nd} side curvilinear platform 306 may be different from the width of the curvilinear bridging platform 300 so as to accommodate the storage of the side platforms 304 and 306 therebeneath. The support rails 310 and 312 of the 2^{nd} side curvilinear platform 306 may have a spaced apart distance which is greater than the spaced apart distance of the support rails under the 1^{st} side curvilinear platform 304 so as to accommodate their respective overlapping over and under, or side-by-side storage arrangement positioned beneath the curvilinear bridging platform 300.

The invention thus comprises a support frame platform assembly generally of “C” peripheral shape of up to about 180° in a plan view, with independently slidably adjustable both “outwardly and inwardly” and to a “O” shape or vice versa, for providing an adjustable platform for supporting workers and supplies circularly up to a full 360° about an elevated project such as for example, a chimney. The platform assembly 10 has an elongated curvilinear floor panel “bridging” arrangement with an attached adjacent rear wall member supportively between a pair of adjustable curvilinear platforms at each end thereof. The platform itself is preferably attached to the distal end of an articulable arm 14 of a power lift truck 16 for lifting of the platform assembly 10 up to and around an elevated chimney, standpipe, column 302 or the like.

1-11. (canceled)

12. An articulable, shape-changeable, elevatable platform assembly comprising a generally “H” shaped structure being attachable distal end of an articulable support arm of a transport vehicle, the platform assembly being arranged to adjustably surround an elevated structure on at least three sides thereof, the platform assembly comprising:
an elongated bridging member attachable at a midpoint thereof to the articulable support arm of a transport vehicle, the elongated bridging member having a 1^{st} end and a 2^{nd} end, wherein an elongated 1^{st} side platform is controllably and slidably attached to the 1^{st} end of the elongated bridging member; and wherein an elongated 2^{nd} side platform is independently controllably and independently slidably attached to the 2^{nd} end of the elongated bridging member so as to enable adjustable adaption to size variations of the adjacent and/or parallel sides of a surrounded elevated structure by the platform assembly.

13. The articulable, shape changeable, elevated platform assembly as recited in claim 12, wherein the elongated bridging member has an elongated safety rail on an elongated distal side thereof.

14. The articulable, shape changeable, elevated platform assembly as recited in claim 13, wherein the 1^{st} side platform attached to the 1^{st} end of the elongated bridging member has an elongated safety rail arranged on an outward side thereof.

15. The articulable, shape changeable, elevated platform assembly as recited in claim 14, wherein the 2^{nd} side platform attached to the 2^{nd} end of the elongated bridging member has an elongated safety rail arranged on an outward side thereof.

16. The articulable, shape changeable, elevated platform assembly as recited in claim 15, wherein the 1^{st} side platform attached to the 1^{st} end of the elongated bridging member has a proximal end which is arranged perpendicular to that elongated bridging member.

17. The articulable, shape changeable, elevated platform assembly as recited in claim 16, wherein the 2^{nd} side platform attached to the 2^{nd} end of the elongated bridging member has a proximal end which is arranged perpendicular to that elongated bridging member.

18. The articulable, shape changeable, elevated platform assembly as recited in claim 15, wherein at least one of the elongated side platforms is curved in its elongated direction.

19. The articulable, shape changeable, elevated platform assembly as recited in claim 18, wherein at least one elongated side platform is connected to the elongated bridging member by a supportive rotary unit to permit the at least one side platform to be moved angularly into close non-orthogonal proximity towards and away from a vertical structure.

20. An articulable, shape-changeable, elevatable platform assembly comprising a generally “H” shaped structure being attachable distal end of an articulable support arm of a transport vehicle, the platform assembly being arranged to adjustably surround an elevated structure on at least three sides thereof, the platform assembly comprising:
an elongated bridging member attachable at a midpoint thereof to the articulable support arm of a transport vehicle, the elongated bridging member having a 1^{st} end and a 2^{nd} end, wherein an elongated 1^{st} side platform is controllably and slidably attached to the 1^{st} end of the elongated bridging member; and wherein an elongated 2^{nd} side platform is independently controllably and independently slidably attached to the 2^{nd} end of the elongated bridging member so as to adjustably adapt to size variations of an adjacent and/or parallel sides of a surrounded elevated structure by the platform assembly; and wherein at least one of the elongated side platforms is curved in its elongated direction; and wherein at least one elongated side platform is connected to the elongated bridging member by a supportive rotary unit to permit the at least one side platform to be swivelably moved angularly into close non-orthogonal proximity towards and away from a vertical structure.
